(19) United States
(12) Patent Application Publication
(10) Pub. No.: US 2012/0005727 A1
(43) Pub. Date: Jan. 5, 2012

(54) METHOD FOR USER TERMINAL AUTHENTICATION AND AUTHENTICATION SERVER AND USER TERMINAL THEREOF

(75) Inventors: Duc-Key Lee, Seoul (KR); Jung-Hee Bang, Seoul (KR)

(73) Assignee: KT CORPORATION, Seongnam-city (KR)

(21) Appl. No.: 13/255,837

(22) PCT Filed: Mar. 4, 2010
(86) PCT No.: PCT/KR2010/001356

§ 371 Date: Sep. 9, 2011

(30) Foreign Application Priority Data
Mar. 10, 2009 (KR) 10-2009-0020096
Jun. 29, 2009 (KR) 10-2009-0058150

(51) Int. Cl. G06F 21/20; G06F 15/16

(52) U.S. Cl. 726/3

(57) ABSTRACT

Provided are a method for user terminal authentication and authentication server and user terminal thereof. The method includes receiving authentication request information for accessing a network from the user terminal, processing a EAP authentication procedure according to the authentication request information, transmitting a message related to the EAP authentication procedure to the user terminal, wherein the message includes network rejection information when network rejection is triggered, and the network rejection information includes network rejection reason information and control information for the user terminal to cope with the network rejection.

### TECHNICAL FIELD

The present invention relates to a method for user terminal authentication; and more particularly, to a method for user terminal authentication, and an interface server and a user terminal using the same.

### BACKGROUND ART

Due to the development of a communication system, various types of networks have been realized. An environment including multiple types of networks is referred to as a multi-network environment. In the multi-network environment, a user terminal may access one of networks such as a Wireless Local Area Network (WLAN) network, a Code Division Multiple Access (CDMA) network, and a World Interoperability for Microwave Access (WiMAX) network.

Hereinafter, the WiMAX network will be exemplary described as one of the representative communication networks. The WiMAX network provides a communication service that enables a user to access the Internet at a high speed and to receive data or multimedia contents not only in an indoor place but also at the outside and even during travelling using various types of user terminals such as a personal computer, a notebook computer, a personal digital assistant (PDA), a portable multimedia player (PMP), a handset, and a smart phone. Such a WiMAX service enables a user to use the Internet even in the outdoor place such as streets, parks, and vehicles in travelling unlike a high speed internet service that enables a user to use the Internet only at an indoor place with an internet cable is installed such as home, a school, and an office.

A WiMAX forum has been established by communication service providers, communication equipments manufacturers, and semiconductor manufacturers in order to secure comparability among equipment employing a WiMAX technology. The WiMAX forum uses an Institute of Electrical and Electronics Engineers (IEEE) standard 802.16 of a wide band wireless access technology as a fundamental technology. The WiMAX forum has been trying to advance a related technology from a stationary standard 802.16d to a mobile standard 802.16e.

The WiMAX network is a wireless metropolitan area network (WMAN) technology based on IEEE 802.16 standard. In general, the WiMAX network includes an access service network (ASN) and a connectivity service network (CSN). The access service network (ASN) includes a user terminal such as a mobile station (MS) which is a client, a base station (BS), and an access service network gateway (ASN-GW). The connectivity service network (CSN) includes logical entities such as a policy function (PF) entity, an authentication authorization and accounting (AAA) server, and an application function (AF) entity.

Hereinafter, a logical structure of a WiMAX network will be described.

The mobile station (MS) is referred to as a WiMAX terminal that accesses the ASN through a wireless link. An IEEE 802.16D/E standard WMAN access technology is mainly used at a wireless side of a WiMAX network.

The ASN guarantees establishing connection between a WiMAX terminal and a WiMAX base station (BS). The ASN manages wireless resources, finds a network, selects an optimal a network service provider (NSP) for a WiMAX subscriber, operates as a proxy server for controlling authentication authorization and accounting (AAA) of a WiMAX subscriber in a proxy mobile intern protocol (MIP), and accesses an application through a WiMAX terminal.

The CSN allocates an Internet protocol (IP) address for a session of a WiMAX subscriber, provides access for Internet, operates as an AAA proxy or an AAA server, performs a policy and controls access based on the subscribing data of a subscriber, supports establishing a tunnel between the ASN and the CSN, generates an invoice for a WiMAX subscriber, supports a policy of a WiMAX service through an operator, supports forming a loaming tunnel between CSNs, supports mobility between ASNs, provides a location based service, provides an end-to-end service, and supports various WiMAX services such as multimedia broadcast service and a multimedia broadcast multicast service (MBMS).

FIG. 1 is a diagram illustrating a network system according to the related art.

Referring to FIG. 1, the network system according to the related art includes a user terminal 110, a communication system 120, an Internet network 130, and an application service provider 140.

The user terminal 110 is any devices that can access a network including a communication system. For example, the user terminal 110 may be a notebook computer, a personal computer, a personal digital assistant (PDA), a hand set, or a personal multimedia player (PMP).

The communication system 120 includes a base station 121 or a radio access station (RAS) for controlling connection of a physical communication channel, an Access Service Network Gate Way (ASN-GW) 122 or Base Station Controller/Serving GPRS Supporting Node (BSC/SGSN) for controlling Medium Access Control (MAC) of an access network, Connectivity Service Network (CSN) 123 or Packet Data Service Node/Gateway GPRS Support Node (PDSN/GGSN) for controlling connection of a network layer. The communication system 120 may further include a location information server (LIS), a device capability server, a user profile server, a quality of service server (QoS), and a billing server.

The application service provider 140 has servers for providing a predetermined service to the user terminal 110. The application service provider 140 may include an Internet Protocol Television (IPTV) server for providing an Internet based television programs to a user terminal 110 accessing the Internet network 130, a contents server for providing music/video contents in real time, a search engine server for providing a result of a search inquiry in response to a request of the user terminal 110, an advertisement server for providing advertisement, and a service server 139 for providing services.

Extensible Authentication Protocol (EAP) is defined in a Request for Comments or Remote Function Call (RFC) standard by Internet Engineering Task Force (IETF). EAP is a protocol for performing authentication when a user terminal accesses the Internet. EAP has been widely used in various types of networks such as a wireless local area network and a WiBRO (WiMAX) network. An EAP authentication server authenticates a user terminal using various EAP methods such as TLS, TTLS, and AKA. In case of the success of authentication, the EAP authentication server transfers an EAP-Success message to a user terminal through a Network Access Server (NAS) disposed between the user terminal and the authentication server. In case of the failure of authentication, the EAP authentication server transfers an EAP-Failure message to the user terminal.

When the EAP-failure message is received, the user terminal is denied to access the Internet by a network access server (NAS). In general, the user terminal automatically retries access to the Internet several times. When the user terminal finally fails to access the Internet, the user terminal enters to a waiting state for waiting input from a user. Since there is no standard defined for re-access after authentication failure, the number of retry times for re-access or an interval for re-access in a user terminal is determined by an algorithm or a policy defined by a user terminal manufacturer.

According to causes of authentication failure, a user terminal may finally grant authentication through retrying re-access. However, a user terminal could continuously fail to grant authentication through numerous re-access tries. When the authentication failure repeats because the user terminal automatically tires re-access, it may generate significantly large load in related networks and authentication servers.

In general, the user terminal is not informed why an authentication server denies the network access of the user terminal. Therefore, the user terminal automatically tires re-accessing in case of authentication failure. Therefore, if the user terminal is informed of a reason of network access failure with instructions for re-access from the authentication server, it is possible to significantly reduce load in the networks and the authentication servers.

### DISCLOSURE

### Technical Problem

An embodiment of the present invention is directed to providing a method for user terminal authentication that provides network access denying reasons to a user terminal.

An embodiment of the present invention is directed to providing a method for user terminal authentication that provides reaccess instructions to a user terminal according to network access denying reasons in order to reduce unnecessary re-access tries and significantly reduce load in an authentication server.

An embodiment of the present invention is directed to providing a method for user terminal authentication that prevents a serious security problem when network access denying reasons and reaccess instructions are forged or modulated.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for authenticating a user terminal, including: receiving authentication request information for accessing a network from the user terminal; processing a EAP authentication procedure according to the authentication request information; and transmitting a message related to the EAP authentication procedure to the user terminal, wherein the message includes network rejection information when network rejection is triggered, and the network rejection information includes network rejection reason information and control information for the user terminal to cope with the network rejection.

In accordance with another aspect of the present invention, there is provided an apparatus for authenticating a user terminal, including: a receiver configured to receive authentication request information from the user terminal to access a network; an EAP authentication procedure processor configured to process an authentication procedure according to the authentication request information; and a transmitter configured to transmit a message related to the EAP authentication procedure to the user terminal, wherein the message includes network rejection information when network rejection is triggered, and the network rejection information includes network rejection reason information and control information for a user terminal to cope with the network rejection.

In accordance with another aspect of the present invention, there is provided a method for authenticating a user terminal, including: transmitting authentication request information for accessing a network to an authentication server; and receiving a message related to an EAP authentication procedure processed according to the authentication request information from the authentication server, wherein the message includes network rejection information when network rejection is triggered, and the network rejection information includes network rejection reason information and control information for the user terminal to cope with the network rejection.

In accordance with another aspect of the present invention, there is provided an apparatus apparatus for authenticating a user terminal, including: a transmitter configured to transmit authentication request information for accessing a network to an authentication server; and a receiver configured to receive a message related to an EAP authentication procedure processed according to the authentication request information from the authentication server, wherein the message includes network rejection information when network rejection is triggered, and the network rejection information includes network rejection reason information and control information for the user terminal to cope with the network rejection.

In accordance with another aspect of the present invention, there is provided a method for authenticating a user terminal, including: receiving authentication request information for accessing a network from the user terminal; processing an EAP-TLS authentication procedure according to the authentication request information; and transmitting a EAP-Request/Notification message related to the EAP-TLS authentication procedure to the user terminal, wherein the EAP-Request/Notification message includes the network rejection information when network rejection is triggered, and the network rejection information includes network rejection reason information and control information for the user terminal to cope with the network rejection.

In accordance with another aspect of the present invention, there is provided a method for authenticating a user terminal, including: receiving authentication request information for accessing a network from the user terminal; processing an EAP-TTLS authentication procedure according to the authentication request information; and transmitting a EAP-Request/Notification message related to the EAP-TTLS authentication procedure to the user terminal, wherein the EAP-Request/Notification message includes the network rejection information when network rejection related to authentication failure or authorization failure is triggered during the the EAP-TTLS authentication procedure, and the network rejection information includes network rejection reason information and control information for the user terminal to cope with the network rejection.

In accordance with another aspect of the present invention, there is provided a method for authenticating a user terminal, including: receiving authentication request information for accessing a network from the user terminal; processing an EAP-AKA authentication procedure according to the authentication request information; and transmitting a EAP-Request/Notification message related to the EAP-AKA authentication procedure to the user terminal, wherein the EAP-Request/Notification message includes the network rejection information when network rejection is triggered, and the network rejection information includes network rejection reason information and control information for the user terminal to cope with the network rejection.

In accordance with another aspect of the present invention, there is provided a computer readable recording medium storing a method for authenticating a user terminal, the method including: processing an EAP authentication procedure according to authentication request information from a user terminal for accessing a network; and generating a message including result information according to the EAP authentication procedure, wherein the result information includes network rejection information when network rejection is triggered, and the network rejection information includes network rejection reason information and control information for the user terminal to cope with the network rejection.

In accordance with another aspect of the present invention, there is provided a computer readable recording medium storing a method for authenticating a user terminal, the method including: generating authentication request information for accessing a network; and analyzing a message including result information of an EAP authentication procedure processed according to the authentication request information received from the authentication server, wherein the result information includes network rejection information when network rejection is triggered, and the network rejection information includes network rejection reason information and control information for the user terminal to cope with the network rejection.

### Advantageous Effects

A method for user terminal authentication according to the present invention can reduce load in a network and an authentication server by effectively controlling accessing a network when a user terminal fails to grant authentication of accessing a network.

Further, the method for user terminal authentication according to the present invention can provide integrity protection as solution to overcome a serious security problem that may be caused by forging or modulating network access denying reasons and reaccess instructions provided to a user terminal.

### BRIEF DESCRIPTION OF THE DRAWINGS

FIG. 1 is a diagram illustrating a network system according to the related art.

FIG. 2 is a diagram illustrating a procedure of a user terminal for accessing a network.

FIG. 3 is a diagram illustrating a procedure of a user terminal for accessing a network in case of authentication failure.

FIG. 4 is a diagram illustrating a network access rejection procedure in an EAP authentication process when a user terminal is failed to be authenticated for accessing a network.

FIG. 5 is a diagram illustrating an authentication server in accordance with an embodiment of the present invention.

FIG. 6 is a diagram illustrating a user terminal in accordance with an embodiment of the present invention.

FIG. 7 is a diagram illustrating a network access rejection procedure in EAP-TLS.

FIG. 8 is a diagram illustrating a network access rejection procedure in EAP-TTLS.

FIG. 9 is a diagram illustrating a network access rejection procedure in EAP-AKA.

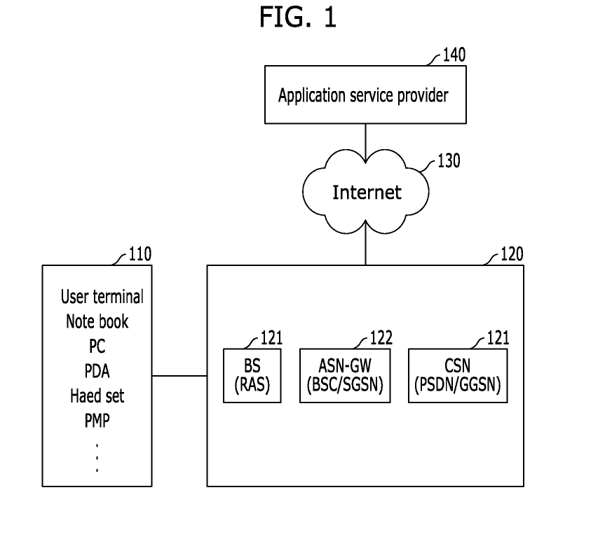

### BEST MODE FOR THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like.

To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Hereinafter, a procedure of a user terminal for accessing a network will be described.

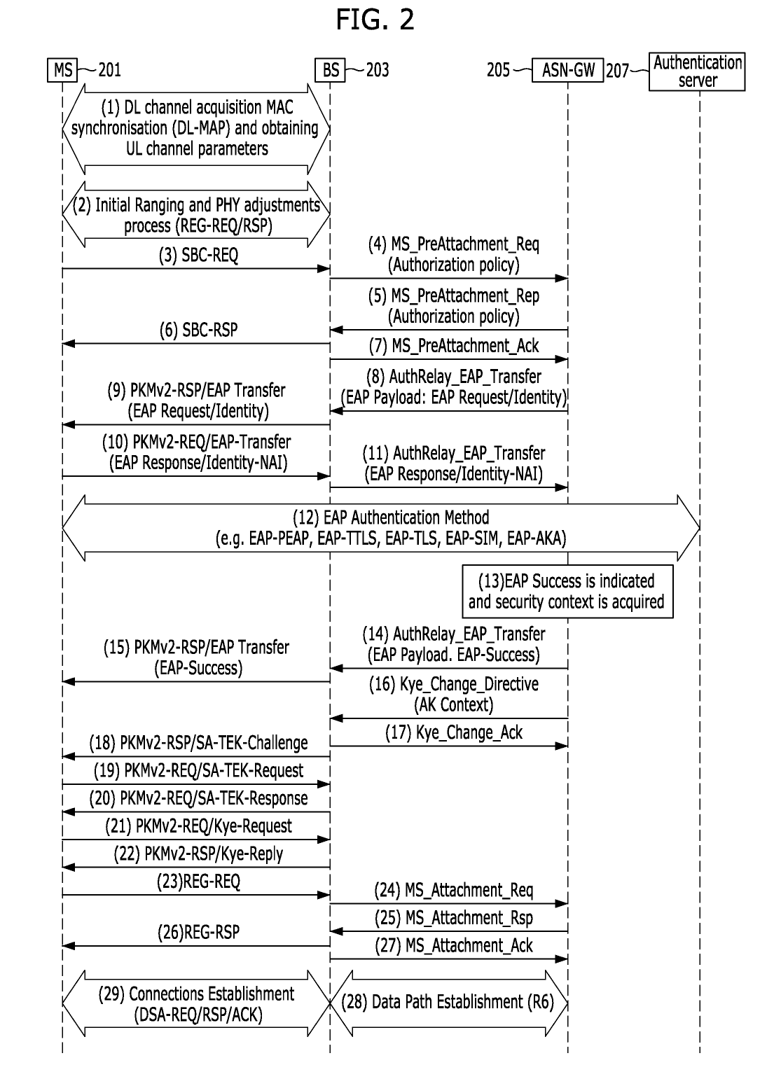

FIG. 2 is a diagram illustrating a procedure of a user terminal for accessing a network. In order to describe the procedure of a user terminal for accessing a network, a WiMAX network is exemplarily described in FIG. 2. FIG. 2 describes the procedure of a user terminal for accessing a network based on an EAP authentication procedure between a user terminal and a network when a user terminal initially accesses a network.

As shown in FIG. 2, the network includes a mobile station (MS) 201, a base station (BS) 203, an access network gateway (ASN-GW) 205, and an authentication server 207. The mobile station (MS) 201 may be any device that can access a network. The mobile station (MS) 201 is a user terminal such as a notebook computer, a personal computer, a personal digital assistant (PDA), a hand set, or a personal multimedia player (PMP). The authentication server 207 authenticates the network access of the mobile station 201. The authentication server 207 may be an Authentication Authorization Accounting (AAA) server. The AAA server may perform authentication, authorization, and accounting for accessing resources and providing services. In general, the AAA server interacts with database and directories storing user information through accessing a network and interacting with a gateway server. In order to perform such operations, the AAA server employs protocol such as a Remote Authentication Dial-In User Service (RADIUS) and DIAMETER.

Each operation in the procedure of a user terminal for accessing a network will be described in detail with reference to FIG. 2.

(1) A user terminal acquires down-link (DL), performs Medium Access Control (MAC) synchronization, and obtains up-link (UL) channel parameters.

(2) A user terminal performs initial ranging and physical layer (PHY) adjustment. In order to process such operations, the user terminal exchanges a Ranging Request (RNG-REQ) message and a Ranging Response (RNG-RSP).

(3) The mobile station (MS) 201 transmits a PSS Basic Capability Request (SBC-REQ) message to the base station (BS) 203.

(4) The base station (BS) 203 transmits an MS_PreAttachment_Req message to the ASN-GW 205 in order to inform that a new mobile station 201 enters a network.

(5) The ASN-GW 205 transmits a MS_PreAttachment_Rsp message to the BS 203 as a response to the MS_PreAttachment_Req message.

(6) After the ASN-GW 205 and the BS 203 exchange the MS_PreAttachment_Req message and the MS_PreAttachment_Rsp message, the BS 203 transmits a PSS Basic Capability Response (SBC-RSP) message to the MS 201.

(7) Simultaneously, the BS 203 transmits a MS_PreAttachment_Ack message to the ASN-GW 205.

(8) After completing MS_PreAttachment, the ASN-GW 205 starts an EAP authentication procedure. The ASN-GW 205 transmits an EAP Request/Identity message to the BS 203 using an Authentication Relay protocol (AR_EAP_Transfer).

(9) The BS 203 relays the EAP Request/Identity payload to the MS 201 through a PKMv2 (Privacy Key Management Version2)-RSP/EAP-Transfer message.

(10) The MS 201 transmits a network access identifier (NAI) to the BS 203 using the PKMv2-REQ/EAP-Transfer message in response to the EAP Request/Identity.

(11) The BS 203 transmits EAP payload included in the PKMv2-REQ/EAP-Transfer message to the ASN-GW 205 using Authentication Relay protocol (AR_EAP_Transfer).

(12) The ASN-GW 205 analyzes the NAI and transmits the EAP payload to the authentication server 207. The MS 201 and the authentication server 207 perform the EAP authentication process.

(13) The ASN-GW 205 receives an authentication result.

(14) The ASN-GW 205 transmits the authentication result to the BS 203 using the Authentication Relay protocol (AR_EAP_Transfer).

(15) The BS 203 relays the EAP payload to the MS 201 using the PKMv2 EAP-Transfer/PKM-RSP message.

(16) The ASN-GW 205 transmits a Key_Change_Directive message to the BS 203 in order to inform the completion of the EAP authentication process.

(17) The BS 203 transmits a Key_Change_Ack message to the ASN-GW 205 as a response to the Key_Change_Directive message.

(18-20) The BS 203 and the MS 201 perform a PKMv2 3-way handshake. While performing the PKMv2 3-way handshake, SA-TEK-Challenge/Request/Response messages are exchanged.

(21-22) The MS 201 obtains valid TEK keys by exchanging PKMv2 Key-Request/Reply messages between the BS 203 and the MS 201.

(23) After completing the PKMv2 3-way handshake, the MS 201 transmits a registration request (REG REQ) message to the BS 203. The REG REQ message includes information about CS capabilities, Mobility parameters, and Handover support.

(24-25) The BS 203 transmits a MS_Attachment_Req message to the ASN-GW 205. The ASN-GW 205 transmits a MS_Attachment_Rsp message to the BS 203 as a response to the MS_Attachment_Req message.

(26) The BS 203 transmits a registration response (REG RSP) message to the MS 201.

(27) The BS 203 transmits a MS_Attachment_Ack message to the ASN-GW 205 after transmiting a registration response (REG RSP) message to the MS 201.

(28-29) The ASN-GW 205 generates Initial service flow (ISF), builds a data path to the BS 203 and the MS 201, and establishes connection thereto.

Hereinafter, a procedure of a user terminal for accessing a network in case of authentication failure will be described.

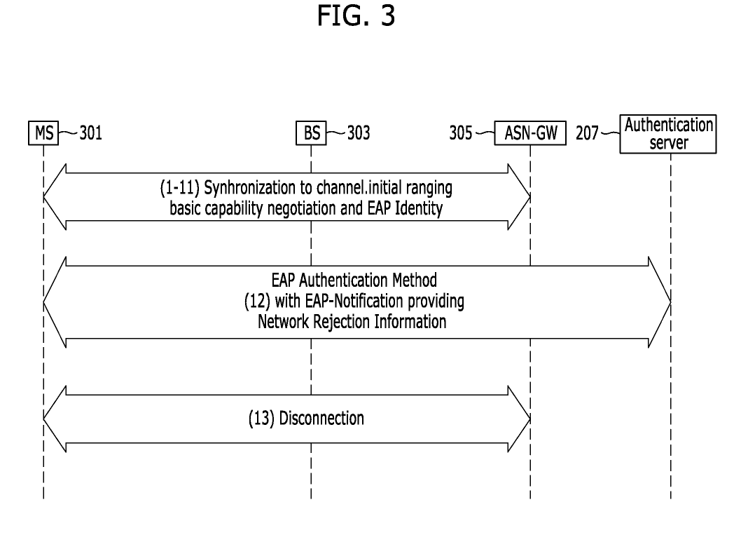

FIG. 3 is a diagram illustrating a procedure of a user terminal for accessing a network in case of authentication failure. Like the network of FIG. 2, a network shown in FIG. 3 includes a mobile station (MS) 301, a base station (BS) 303, an access network gateway (ASN-GW) 305, and an authentication server 307.

A user terminal searches a wireless signal, acquires a channel, and accesses a network access server. These processes are equivalent to the operations (1) to (11) of FIG. 2. Therefore, the operations (1) to (11) are identically applied to the procedure of FIG. 3.

(12) The ASN-GW 305 analyzes the NAI and transmits the EAP payload to the authentication server 307. The MS 301 and the authentication server 307 perform the EAP authentication process. When the MS 301 is rejected to access the network, the authentication server 307 transmits network rejection information to the MS 301. The ASN-GW 305 may relay an EAP message and payload from the BS 303.

(13) The MS 301, the BS 303, and the ASN-GW 305 perform a disconnection procedure.

Hereinafter, the EAP authentication process in case of user terminal authentication failure will be described in more detail.

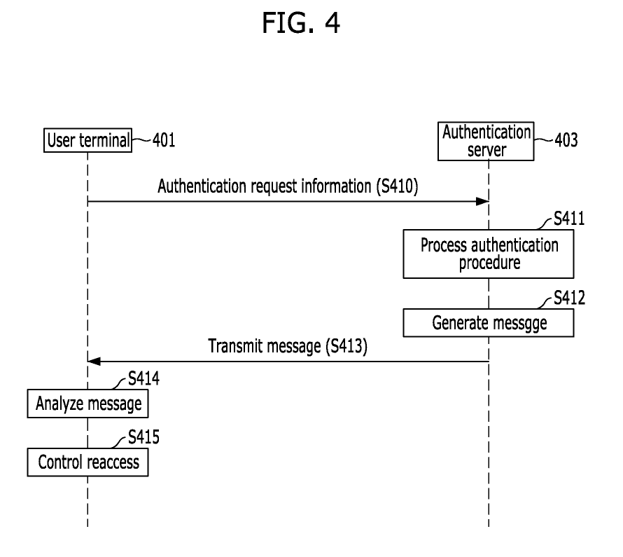

FIG. 4 is a diagram illustrating a network access rejection procedure in an EAP authentication process when a user terminal is failed to be authenticated for accessing a network. That is, FIG. 4 describes a network access rejection procedure performed when a user terminal fails to be authenticated for accessing a network. The network access rejection procedure will be described in detail based on a MS 401 and an authentication server 403.

It is preferable that the network access rejection procedure according to the present embodiment is performed in an EAP authentication process. However, the network access rejection procedure according to the present embodiment may be applied to a general authentication process that authenticates a user terminal 401 for accessing a network. Here, the user terminal 401 may include a mobile station (MS).

The network access rejection procedure according to the present embodiment provides network access rejection reasons to the user terminal 401 when the user terminal 401 is rejected to access a network. The network access rejection reasons are reasons why the user terminal 401 is rejected to access the network. Therefore, the user terminal 401 is enabled to perform a proper operation corresponding to the received network access rejection reasons.

Referring to FIG. 4, the user terminal 401 transmits authentication request information to the authentication server 403 for authenticating accessing a network. At step S411, the authentication server 403 performs an authentication procedure according to the authentication request information received from the user terminal 401. The authentication procedure may include an EAP authentication procedure. In case of the EAP authentication procedure, the authentication procedure may be performed by selecting one of specific EAP authentication methods such as EAP-TLS, EAP-TTLS, and EAP-AKA. Each of EAP-TLS, EAP-TTLS, and EAP-AKA authentication methods will be described in later.

When an authentication failure reason of the user terminal 401 is found during the authentication procedure, the authentication procedure is terminated by EAP. Here, the authentication failure may be reason by rejecting a user terminal to access a network. When a reason of rejection the user terminal to access a network is found, the authentication server 403 generates a message including authentication failure reason information and control information according to the authentication failure reason at step S412 and transmits the generated message to the user terminal 401 at step S413.

In detail, when a network access rejection reason is found, the authentication server 403 generates a message according to a result of an authentication procedure before the authentication procedure ends. Particularly, when authentication of the user terminal 401 is rejected, the message includes network rejection information. The network rejection information includes authentication failure reason information and control information for coping with the authentication failure reason. The control information is about instructions for the user terminal 401 to cope with network access rejection according to the network rejection information after disconnecting the user terminal 401 from the network according to the network access rejection procedure. For example, the control information includes information about coping with the authentication failure, such as reaccess-try information or access-standby information after disconnection from a network.

Here, the message may be an EAP message in case of an EAP based authentication. In detail, authentication failure reason information and control information for the user terminal 401 may be transmitted to the user terminal 401 using an EAP-Notification Request message.

In a conventional EAP standard, an authentication server uses an EAP-Notification Request message to send a character string in a UTF-8 format to a user terminal. Further, a user terminal uses the EAP-Notification Request message to display the character string on a display unit. In the present embodiment, the EAP-Notification Request message expands to add access rejection reason information in a Type-Length-Value (TLV) format after the character string. Accordingly, the user terminal 401 analyzes the access rejection information and performs corresponding operations according to the analysis result. The EAP-Notification Request message will be described in more detail in later.

Meanwhile, the network rejection information further includes rejection reason authentication information for integrity protection of the network rejection information. For example, Rejection Message Authentication Code (RMAC) may be the rejection reason authentication information.

The rejection reason authentication information may be generated using a master session key (MSK) or an extended master session key (EMSK). Since the MSK or the MESK is for generating the rejection reason authentication information for protecting the network rejection information, the MSK or the EMSK must be generated in the authentication server 403 before the authentication server 403 transmits messages related to the authentication procedure to the user terminal 401. Therefore, the message related to the authentication procedure can be generated anytime after the MSK or the EMSK are generated.

Here, the integrity protection may be performed by comparing the rejection reason authentication information with rejection reason authentication information of the user terminal, which is generated using the MSK or the EMSK of the user terminal 401.

At step S414, the user terminal 401 analyzes a message transmitted from the authentication server 403. The user terminal 401 also generates rejection reason authentication information of the user terminal 401 using the MSK or the EMSK of the user terminal 401 for integrity protection. The user terminal 401 protects the network rejection information from malicious attack such as forge or modulation by comparing the rejection reason authentication information generated by the authentication server 401 with the rejection reason authentication information generated by the user terminal 403. For example, the user terminal 401 and the authentication server 403 generate a MSK or an EMSK having the same value and use the same algorithm to calculate RMAC in case of RMAC. Therefore, RMAC values generated by the user terminal 401 and the authentication server 403 become identical except forged or modulated RMAC. The user terminal 401 ignores the received network rejection information when the network rejection information does not include a RMAC value or when a RMAC value generated by the user terminal 401 is not identical to a RMAC value calculated by the authentication server 403.

Hereinafter, an EAP-Notification Request message will be described in more detail.

The EAP-Notification Request message includes network rejection information. The network rejection information includes authentication failure reason information and control information for a user terminal to cope with authentication failure according to the authentication failure reason information.

Meanwhile, the EAP-Notification Request may further include delimiter information and character strings for displaying. The delimiter information enables to identify a general EAP-Notification Request message from an EAP-Notification Request message having network rejection information. In case of using an EAP-Notification message to transfer the network access rejection information, the EAP-Notification Request message includes a delimiter and network access rejection information. The character string may be added prior to a NULL text which is a delimiter. Since the NULL text is not included in an EAP-Notification message in a conventional EAP standard, the user terminal 401 can determine that the EAP-Notification message includes the network rejection information if the EAP-Notification message includes the NULL text. The user terminal 401 determines a received EAP-Notification message as a conventional standard EAP-Notification message if the received EAP-Notification message does not include the NULL text but character string for displaying.

Table 1 shows formation of a Type-Data field of an EAP-Notification message.

TABLE 1

| Element Name | Length in octets | Description |
|---|---|---|
| Human | Variable | If required, UTF-8 encoded |
| Readable | | human readable message MAY |
| String | | be included prior to the |
| | | NULL character. Then, the MS |
| | | SHOULD displays this message |
| | | to the user if the integrity |
| | | check succeeds. |
| Delimiter | 1 | The NULL character (0x00) |
| Network | Variable | ASCII string that is BASE64- |
| Rejection | | encoded from the Network |
| Information | | Rejection Information TLV. |
| string | | The MS SHOULD NOT display |
| | | this string to the user as |
| | | it is, without proper |
| | | translation. |

Hereinafter, network rejection information will be described.

The network rejection information may be coded into Type-Length-Value (TLV). TLV coded network rejection information is human unreadable format. When the TLV coded network rejection information is not converted into a human readable format, the TVL coded network rejection information is not outputted through a display device of a user terminal. The TLV coded network rejection information is include a Type-Data field of the EAP-Notification Request message and transferred to the user terminal 401.

The network rejection information may include authentication failure reason information and control information for a user terminal 401 to cope with authentication failure according to the authentication failure reason. Here, the authentication failure reason information may be classified by control information. The classified information may be expressed as a predetermined code.

Table 2 shows the network rejection information in detail.

| Type | 3 for Network Rejection information | | |
|---|---|---|---|
| Length in | Variable | | |
| Octets | | | |
| Description | The Network Rejection Information is coded as | | |
| | follows | | |
| | TLV Name | Description | M/0 |
| Elements | Rejection Code | | M |
| (Sub-TLVs) | Received NAI | | M |
| | Emergency Services Overrride | | 0 |
| | Allowed Location Information | | 0 |
| | RMAC (Rejection Message | | M |
| | Authentication Code) Value | | |

In Table 2, “Rejection Code” means a rejection code where authentication failure reason information is separated from control information. The network rejection information may include a rejection code, and the rejection code may be classified by a rejection class which is control information. Table 3 exemplary shows Table 3.

TABLE 3

| Rejection | | Applicability of | Scope of |
|---|---|---|---|
| Class | Rejection Duration/Criteria | Visited/Home AAA | Rejection |
| A | Until Manual Retry | Home AAA | All NAPs |
| B | Until Manual Retry | Visited/Home AAA | V-NSP |
| C | Until Power Cycle | Home AAA | All NAPs |
| D | Until Power Cycle | Visited/Home AAA | V-NSP |
| E | Until Timer Expiry | Home AAA | All NAPs |
| F | Until Timer Expiry | Visited/Home AAA | V-NSP |
| G | Until Location Criteria met | Home AAA | All NAPs |
| H | Until Location Criteria met | Visited/Home AAA | V-NSP |

In Table 3, the rejection class is classified from A to H. “Rejection Duration/Criteria” classifies operations of the user terminal 401 by the network rejection information. For example, “Until manual Retry” is control information that control the user terminal 401 not to access a network until a user of the user terminal 401 manually request re-access. “Until Power Cycle” is control information that controls a user terminal 401 not to access a network until a user of the user terminal 401 manually applies the power of the user terminal 401 again. “Until Timer Expiry” is control information for controlling a user terminal 401 not to access a network until a predetermined time is passed. “Until Location Criteria met” is control information for controlling a user terminal 401 not to access a network until a user terminal arrives at an allowed location of a base station.

Hereinafter, relation between a rejection code and a rejection class will be described.

The rejection code is classified by a rejection class. Table 4 exemplary shows the relation of the rejection code and the rejection class. Here, Table 4 shows rejection classes from A to C among the rejection classes shown in Table 3.

TABLE 4

| | |
|---|---|
| Type | 4 for Rejection Code |
| Length in | 2 |
| Octects | |
| | The Rejection Code value is defined as follows: |
| | Rejection Class A -Rejection Codes in the range |
| | 0x0000-0x00FF |
| | 0x0000 = Rejection Class A -General Error |
| | 0x0001 = Invalid Subscription Information |
| | 0x0002 = Major Network Problem |
| | 0x0003 = Unpaid Bills |
| | 0x0004 = Illegal Mobile Equipment |
| | 0x0005 = Device Type not supported by NSP |
| | 0x0006 = Misbehaving MS Equipment |
| | All other Rejection codes in Rejection Class A are undefined. |
| | Rejection Class B -Rejection Codes in the range |
| | 0x0100-0x01FF |
| | 0x0100 = Rejection Class B -General Error |
| | 0x0101 = No Roaming Agreement existing with the Home or |
| | the Visited Network |
| | 0x0102 = Illegal Mobile Equipment |
| | 0x0103 = Device Type not supported by NSP |
| | 0x0104 = Invalid Subscription/Configuration |
| | 0x0105 = Misbehaving MS Equipment |
| | All other Rejection codes in Rejection Class B are undefined. |
| | Rejection Class C -Rejection Codes in the range |
| | 0x0200-0x02FF |
| | 0x0200 = Rejection Class C -General Error |
| | 0x0201 = Invalid Subscription Information |
| | 0x0202 = Major Network Problem |
| | 0x0203 = Unpaid Bills |
| | 0x0204 = Illegal Mobile Equipment |
| | 0x0205 = Device Type not supported by NSP |
| | 0x0206 = Misbehaving MS Equipment |
| | All other Rejection codes in Rejection Class C are undefined. |

Hereinafter, RMAC will be described in detail. Table 5 exemplarily shows RMAC in detail. As shown in Table 5, 32-byte RMAC-Value is calculated using an EMSK value that is generated as the same value in both of the user terminal 401 and the authentication server 403 in an EAP authentication procedure. While calculating the RMAC-Value, a Value field of RMAC TLV included in Rejection Information TLV is filled with 0. After calculating, the Value field of RMAC TLV is replaced with the RMAC-Value. It is not necessary to share a security key value between the user terminal 401 and the authentication server 403 by using a 512-bit Extended Master Session Key (EMSK) value which is generated as the same value in the user terminal 401 and the authentication server 403 during the EAP standard authentication procedure.

TABLE 5

| | |
|---|---|
| Type | 8 for RMAC (Rejection Message Authentication Code) Value |
| Length in | 32 |
| octets | |
| Value | 32 octet RMAC Value SHALL be generated from the |
| | EMSK using the following formula: |
| | RMAC-Value = HMAC-SHA256(RMAC Key, Network |
| | Rejection Information TLV) |
| | where: |
| | RMAC-1 = HMAC-SHA256(EMSK, usage-data\|0x01) |
| | RMAC-2 = HMAC-SHA256(EMSK, RMAC-1\|usage |
| | data\|0x02) |
| | RMAC-Key = RMAC-1\|RMAC-2 |
| | where: |
| | usage-data = key label + “\0” + length |
| | key label = rmac-key@wimaxforum.org in ASCII |
| | length = 0x0200 the length in bits of the RMAC-Key |
| | expressed as a 2 byte unsigned integer in network order. |
| | RMAC-Value is a 32 octet HMAC-SHA256 digest value, |
| | where the |
| | RMAC-Key is used for the key and the whole Network |
| | Rejection Information TLV is used for the data, except that |
| | the value field of the RMAC Value TLV included in the |
| | Rejection Information is set to zero when calculating the |
| | RMAC-Value. After calculation, the value field of the |
| | RMAC Value TLV included in the Network Rejection |
| | Information TLV is replaced with the calculated |
| | RMAC-Value. |

Hereinafter, an authentication method according to embodiments of the present invention will be described in detail.

### <First User Terminal Authentication Method>

A user terminal authentication method in accordance with an embodiment of the present invention will be described with reference to FIG. 4. The user terminal authentication method according to the present embodiment denotes an authentication method performed by an authentication server 403.

The user terminal authentication method according to the present embodiment includes receiving authentication request information for accessing a network from a user terminal 401; processing an authentication procedure according to the authentication request information; and transmitting a message according to the authentication procedure to the user terminal 401. When the authentication of the user terminal fails, the message includes network rejection information, and the network rejection information includes an authentication failure reason information and control information for a user terminal 401 to cope with authentication failure according to the authentication failure reason.

The authentication procedure may be an Extensible Authentication Protocol (EAP) based authentication procedure. Here, the message may be an EAP message. The EAP message further includes delimiter information.

The network rejection information may be a Type-Length-Value (TLV) code. TLV coded network rejection information is in a human unreadable format. The TLV coded network rejection information cannot be displayed on a display unit of the user terminal 401 if it is not converted in a human readable format. Meanwhile, the TLV coded network rejection information may be included in a Type-Data field of the EAP message. The authentication failure reason information may be classified by control information.

The network rejection information may further include rejection reason authentication information for integrity protection for the network rejection information. Here, rejection reason authentication information may be generated by using a Master Session Key (MSK) or an Extended Master Session Key (EMSK). The integrity protection may be performed by comparing rejection reason authentication information generated by the authentication server 403 with rejection reason authentication reason information of a user terminal 401, which is generated by using an MSK or an EMSK of the user terminal 401.

### <Second User Terminal Authentication Method>

Hereinafter, a user terminal authentication method according to another embodiment of the present invention will be described with reference to FIG. 4. Here, the user terminal authentication method according to the present embodiment denotes an authentication method performed by a user terminal 401.

The user terminal authentication method according to the present embodiment includes: transmitting authentication request information for accessing a network to an authentication server 403; and receiving messages related to an authentication procedure processed according to the authentication request information from the authentication server 403. If the authentication of the user terminal 401 is failed as the result of the authentication procedure, the message includes network rejection information. The network rejection information includes authentication fail reason information and control information for a user terminal 401 to cope with the authentication failure according to the authentication failure reason.

The user terminal authentication method according to the present embodiment further includes performing operations according to the control information.

The authentication procedure may be an Extensible Authentication Protocol (EAP) based authentication procedure. Here, the message may be an EAP message. The EAP message may further include delimiter information. The network rejection information may be coded as Type-Length-Value (TLV) code. The TLV coded network rejection information is in a human unreadable format. If it is not transformed into a human readable format, the TLV coded network rejection information may not be displayed on a display device of a user terminal 401. Meanwhile, the TLV coded network rejection information may be included in a Type-Data field of an EAP message, and the authentication failure reason information may be classified by control information.

The network rejection information may further include rejection reason authentication information for integrity protection for network rejection information. The rejection reason authentication information may be generated using a Master Session Key (MSK) or an Extended Master Session Key (EMSK). The integrity protection may be performed by comparing rejection reason authentication information generated in a user terminal 401 with rejection reason authentication information of the authentication server 403, which is generated using a MSK or an EMSK of the authentication server 403.

### <Authentication Sever>

An authentication server employing a method for authenticating a user terminal according to an embodiment of the present invention will be described, hereinafter.

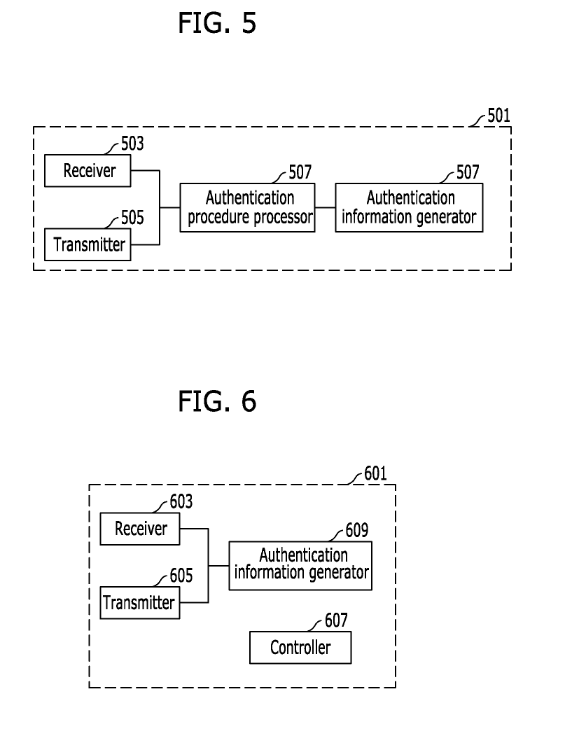

FIG. 5 is a diagram illustrating an authentication server in accordance with an embodiment of the present invention. Referring to FIG. 5, the authentication server 501 according to the present embodiment includes a receiver 503, a transmitter 505, and an authentication procedure processor 507.

The receiver 503 receives authentication request information from a user terminal to access a network. The authentication procedure processor 507 processes authentication procedure according to the authentication request information. The transmitter 505 transmits messages generated by the authentication procedure to the user terminal. If the authentication of a user terminal fails, the message includes network rejection information. The network rejection information includes authentication failure reason information and control information for a user terminal to cope with the authentication failure according to the authentication failure reason.

Here, the authentication procedure may be an Extensible Authentication Protocol (EAP) based authentication procedure. Here, the message may be an EAP message. The EAP message may further include delimiter information. The network rejection information may be coded as Type-Length-Value (TLV) code. The TLV coded network rejection information is in a human unreadable format. If it is not transformed into a human readable format, the TLV coded network rejection information may not be displayed on a display device of a user terminal. Meanwhile, the TLV coded network rejection information may be included in a Type-Data field of an EAP message, and the authentication failure reason information may be classified by control information.

The network rejection information may further include rejection reason authentication information for integrity protection for network rejection information. In this case, the authentication server 501 may further include an authentication information generator 509. The rejection reason authentication information may be generated using a Master Session Key (MSK) or an Extended Master Session Key (EMSK). The integrity protection may be performed by comparing rejection reason authentication information generated by the authentication server 501 with rejection reason authentication information of a user terminal, which is generated using a MSK or an EMSK of the user terminal.

### <User Terminal>

A user terminal employing a method for authentication a user terminal according to an embodiment of the present invention will be described, hereinafter.

FIG. 6 is a diagram illustrating a user terminal in accordance with an embodiment of the present invention. Referring to FIG. 6, the user terminal 601 includes a receiver 603 and a transmitter 605.

The transmitter 605 transmits authentication request information for accessing a network to an authentication server. The receiver 605 receives a message related to an authentication procedure processed according to the authentication request information from the authentication server. If the authentication of the user terminal 601 fails, the message may include network rejection information. The network rejection information includes authentication failure reason information and control information for a user terminal 601 to cope with the authentication failure according to the authentication failure reason.

The user terminal 601 may further include a controller 607 for performing control operations according to the control information.

The authentication procedure may be an Extensible Authentication Protocol (EAP) based authentication procedure. Here, the message may be an EAP message. The EAP message may further include delimiter information. The network rejection information may be coded as Type-Length-Value (TLV) code. The TLV coded network rejection information is in human unreadable format. If it is not transformed into a human readable format, the TLV coded network rejection information may not be displayed on a display device of a user terminal 601. Meanwhile, the TLV coded network rejection information may be included in a Type-Data field of an EAP message, and the authentication failure reason information may be classified by control information.

The network rejection information may further include rejection reason authentication information for integrity protection for network rejection information. In this case, the user terminal 601 may further include an authentication information generator 609. The rejection reason authentication information may be generated using a Master Session Key (MSK) or an Extended Master Session Key (EMSK). The integrity protection may be performed by comparing rejection reason authentication information generated by the user terminal 601 with rejection reason authentication information of an authentication server, which is generated using a MSK or an EMSK of the authentication server.

The method of the present invention described above can be realized as a program and stored in a computer-readable recording medium such as CD-ROM, RAM, ROM, floppy disks, hard disks, magneto-optical disks and the like. Since the process can be easily implemented by those skilled in the art to which the present invention pertains, further description will not be provided herein. Particularly, the method of the present invention can be realized as a computer readable recoding medium storing a method for user terminal authentication where the method including processing an authentication procedure according to authentication request information from a user terminal for accessing a network an d generating a message including result information according to the authentication procedure. When the user terminal fails to be authenticated, the result information includes network rejection information. The network rejection information includes authentication failure reason information and control information for the user terminal to cope with the authentication failure based on the authentication failure reason information. Further, the method of the present invention can be realized as a computer readable recording medium for storing a method for user terminal authentication where the method including generating authentication request information for accessing a network and analyzing a message including a result of authentication procedure processed according to the authentication request information received from the authentication server. When the user terminal fails to be authenticated, the result information includes network rejection information. The network rejection information includes authentication failure reason information and control information for the user terminal to cope with the authentication failure according to the authentication failure reason.

Hereinafter, exemplary applications of the present invention will be described. Particularly, a network access rejection procedure in an EAP-TLS, an EAP-TTLS, and an EAP-AKA will be described.

### <Network Access Rejection Procedure in EAP-TLS>

An EAP-TLS authentication protocol is an Xl.509 certificate based authentication protocol. Here, EAP stands for Extensible Authentication Protocol and TLS denotes Transport Level Security. The EAP-TLS authentication protocol includes a procedure that an authentication server authenticates a user terminal using a certificate of a user terminal and a procedure that a user terminal authenticates an authentication server using a certificate of the authentication server. A user who wants to use an Internet service needs to be authenticated before using the Internet service. Here, mutual authentication may be performed between a user terminal and an authentication server.

A Master Session Key (MSK) or an Extended MSK (EMSK) may be generated like Eq. 1.

MSK(0,63)=TLS-PRF-64(master secret, “client EAP encryption”, random)

EMSK(0,63)=second 64 octets of: TLS-PRF-128(master secret, “client EAP encryption”, random) [Eq. 1]

In Eq. 1, master secret denotes a value shared in a TLS handshake procedure as a method defined in a TLS protocol. Random denotes client.random∥server.random.

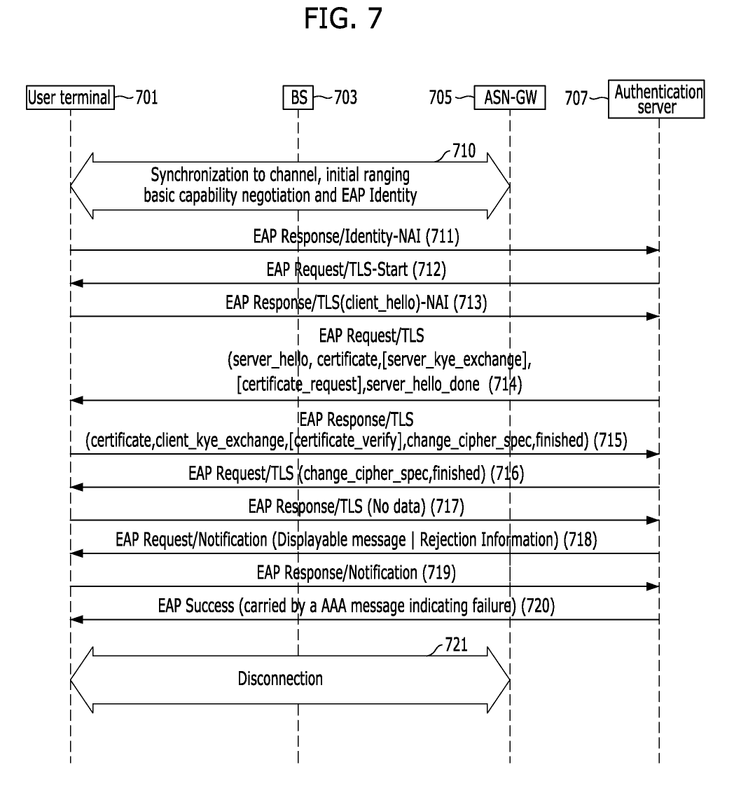

FIG. 7 is a diagram illustrating a network access rejection procedure in EAP-TLS. Referring to FIG. 7, at step S710, a user terminal, a base station, and an ASN-GW acquire a channel and access a network access server. The network access rejection procedure will be described based on connection between the user terminal and the authentication server.

The user terminal receives an EAP-Request/Identity message from the authentication server to request an identity of a user terminal. A Network Access Identifier (NAI) value is set as an Identity value of the EAP-Request/Identity message as a response to the EAP-Request/Identity message and the set NAI value is transmitted to the authentication server at step S711.

The authentication server generates an EAP-Request/TLS-Start message when receiving the EAP-Response/Identity and transmits the generated EAP-Request/TLS-Start message to the user terminal at step S712.

When the user terminal receives the EAP-Request/TLS-Start message, the user terminal generates an EAP-Response/TLS(client _hello) message and transmits the generated EAP-Response/TLS(client_hello) message to the authentication server at step S713.

When the authentication server receives the EAP-Response/TLS(client_hello) message, the authentication server generates and transmits an EAP-Request/TLS(server_hello, certificate, [server_key_exchange], [certificate_request], server_hello_done) message to the user terminal at step S714.

When the user terminal receives the EAP-Request/TLS(server_hello, certificate, [server_key_exchange], [certificate_request], server_hello_done) message and receives EAP-Response/EAP-TLS.client_hello messasge, the user terminal transmits the EAP-Response/TLS(certificate, client_key_exchange], [certificate_verify], change_chiper_spec, finish) message to the authentication server at step S715.

When the authentication server receives EAP-Response/TLS(certificate, client_key_exchange], [certificate_verify], change_chiper_spec, finish) message, the authentication server transmits an EAP-Request/TLS(change_chiper_spec, finish) message to the user terminal at step S716. The user terminal authenticates the authentication server by verifying TLS finished and transmits related message to the authentication server at step S717.

Meanwhile, the authentication server includes an AAA-Key (MSK) into an AVP of a Diameter(RADIUS)/EAP-Transfer message and transmits the Diameter(RADIUS)/EAP-Transfer message to an Access Control Router (ACR). Then, the ACR safely stores the received AAA-Key (MSK).

When the authentication server denies the access or the authentication of the user terminal, the authentication server transmits an EAP-Request/Notification (Displayable message/Rejection Information) message to the user terminal at step S718.

It was described with reference to FIG. 4. The user terminal transmits the SAP-Response/Notification message to the authentication server as a response to the EAP-Request/Notification message at step S719.

The authentication server transmits a message informing authentication failure to the user terminal at step S720 and releases connection to the user terminal, the base station, and the ASN-GW at step S721.

### <Network Access Rejection Procedure in EAP-TTLS>

An EAP-TTLS (Tunneled TLS) Authentication Protocol is the extension of an EAP-TLS authentication protocol. The EAP-TTLS authentication protocol includes a first phase that a user terminal authenticates an authentication server using certificate of an authentication server and establishes a TLS (Transport Level Security) tunnel and a second phase that the authentication server authenticates the user terminal or a user on the safe TLS tunnel.

The Master Session Key (MSK) and the Extended MSK (EMSK) may be generated like Eq. 2.

MSK(0,63)=TLS-PRF-64(SecurityParameter.master secret, “ttls key material”,random)

EMSK(0,63)=second 64 octets of: TLS-PRF-128(SecurityParameter.master_secret, “ttls keying material”, random) [Eq. 2]

In Eq. 2, SecurityParameter denotes each parameter exchanged in a TTLS handshake procedure. master_secret denotes a value negotiated in a TTLS handshake procedure in a method defined in a TLS protocol. Random denotes SecurityParameter.client_hello.random∥SecurityParameter.server_hello.random.

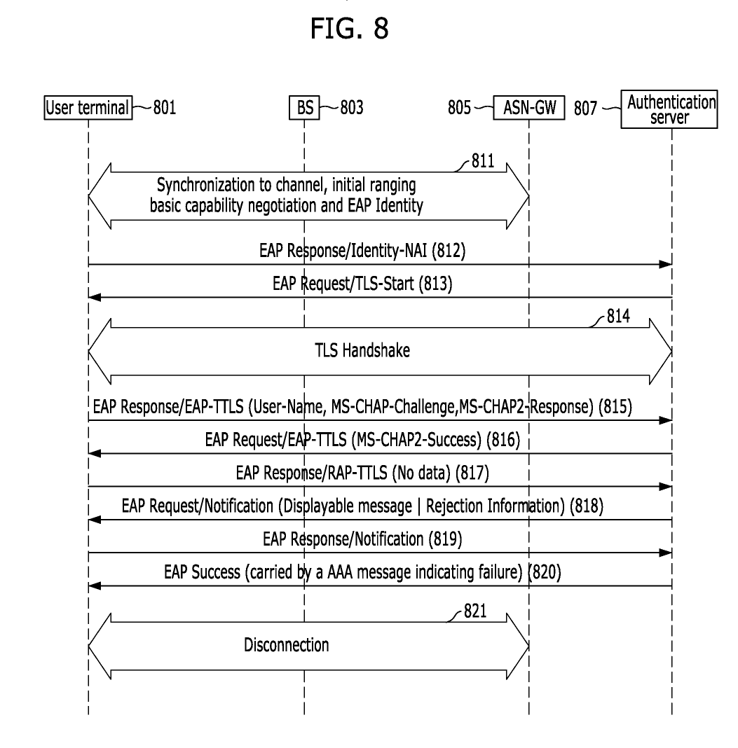

FIG. 8 is a diagram illustrating a network access rejection procedure in EAP-TTLS. Referring to FIG. 8, a user terminal, a base station, and an ASN-GW acquire a channel and access a network access server at step S811. The network access rejection procedure will be described based on connection between the user terminal and the authentication server.

The user terminal receives an EAP-Request/Identity message that asks the identity of the user terminal from the authentication server, sets a Network Access Identifier (NAI) value of the user terminal as an Identity value of the EAP-Response/Identity message, and transmits the NAI of the user terminal to the authentication server at step S812.

When the authentication server receives the EAP-Response/Identity message, the authentication server generates and transmits an EAP-Request/TTLS-Start message to the user terminal at step S813.

The user terminal and the authentication server perform a TLS Handshake procedure at step S814.

The above procedure is the first phase that the user terminal authenticates the authentication server using the certificate of the authentication server and establishes the TLS tunnel.

Hereinafter, the second phase that the authentication server authenticates the user terminal or a user on the TLS tunnel will be described.

The user terminal generates an EAP-Response/EAP-TTLS.MSCHAP-V2 message formed of user-name, MS-CHAPChallenge, and MS-CHAP2-Response and transmits the EAP-Response/EAP-TTLS.MSCHAP-V2 message to the authentication server at step S815.

The authentication server performs user authentication using an MSCHAPv2 algorithm. In case of authentication success, the authentication server generates an EAP-Request/EAP-TTLS(MS-CHAP-V2-Success) message with MS-CHAP2-Success set and transmits the EAP-Request/EAP-TTLS(MS-CHAP-V2-Success) message to the user terminal at step S816. Then, the user responses to the authentication server at step S817.

When the authentication server rejects the access or the authentication of the user terminal, the authentication server transmits an EAP-Request/Notification (Displayable message/Rejection Information) to the user terminal at step S818. It was already described with reference to FIG. 4. The user terminal transmits an EAP-Response/Notification message as a response to the EAP-Request/Notification message to the authentication server at step S819.

The authentication server transmits a message of an authentication failure to the user terminal at step S820 and releases the connections to the user terminal, the base station, and the ASN-GW at step S821.

### <Network Access Rejection Procedure in EAP-AKA>

An EAP-AKA Authentication Protocol is an EAP authentication method for authenticating a user terminal and distributing a session key using an AKA procedure in an UMTS. AKA stands for Authentication and Key Agreement.

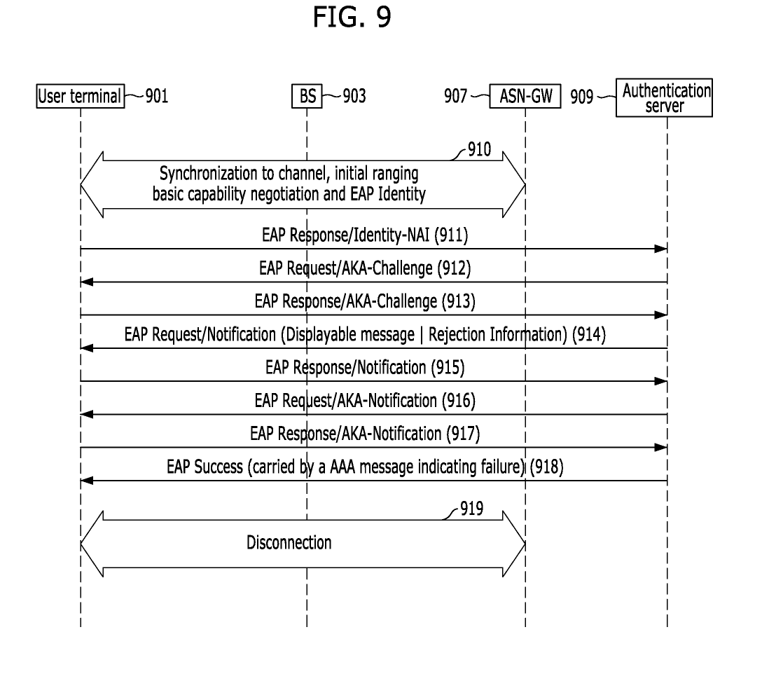

FIG. 9 is a diagram illustrating a network access rejection procedure in EAP-AKA. Referring to FIG. 9, a user terminal, a base station (BS), and an ASN-GW obtain a channel and access a network access server at step S910. The network access rejection procedure will be described based on connection between a user terminal and an authentication server.

The user terminal receives an EAP-Request/Identity message requiring identity of a user terminal from the authentication server, sets a Network Access Identifier (NAI) of the user terminal with the Identity value of the EAP-Request/Identity message, and transmits the NAI to the authentication server at step S911.

The authentication server transmits an EAP-Request/AKA-Challenge message to the user terminal at step S912, and the user terminal transmits an EAP-Response/AKA-Challenge message to the authentication server at step S913.

When the authentication server denies access or authentication of the user terminal, the authentication server transmits an EAP-Request/Notification (Displayable message/Rejection Information) message to the user terminal at step S 914. This procedure is already described with reference to FIG. 4. The user terminal transmits an EAP-Response/Notification message to the authentication server as a response to the EAP-Request/Notification message at step S 915.

The authentication server transmits an EAP-Request/AKA-Notification message to the user terminal at step S916, and the user terminal transmits an EAP-Response/AKA-Notification message to the authentication server as a response to the EAP-Request/AKA-Notification message at step S917.

The authentication server transmits an authentication result, that is, an authentication failure message, to the user terminal at step S918 and releases connections to the user terminal, to the base station, and the ANS-GW at step S919.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

A method for user terminal authentication according to the present invention is applied to a communication system using a network. Particularly, the method for user terminal authentication according to the present invention is used for an authentication procedure.

What is claimed is:

1. A method for authenticating a user terminal, comprising:
receiving authentication request information for accessing a network from the user terminal;
processing an EAP authentication procedure according to the authentication request information; and
transmitting a message related to the EAP authentication procedure to the user terminal,
wherein the message includes network rejection information when network rejection is triggered, and the network rejection information includes network rejection reason information and control information for the user terminal to cope with the network rejection.

2. The method of claim 1, wherein the message is an EAP message and further includes delimiter information.

3. The method of claim 2, wherein the network rejection information is coded by a Type-Length-Value (TLV).

4. The method of claim 3, wherein the TLV coded network rejection information is in a human-unreadable format and is not displayed through a display device of the user terminal unless the TLV coded network rejection information is converted into a human-readable format.

5. The method of claim 3, wherein the TLV coded network rejection information is included in a Type-Data field of the EAP message.

6. The method of claim 1, wherein the network rejection information further includes rejection reason authentication information for integrity protection for the network rejection information.

7. The method of claim 6, wherein the rejection reason authentication information is generated using a Master Session Key (MSK) or an Extended Master Session Key (EMSK).

8. The method of claim 7, wherein the integrity protection is performed by comparing the rejection reason authentication information with rejection reason authentication information of the user terminal, which is generated using a MSK or an EMSK of the user terminal.

9. An apparatus for authenticating a user terminal, comprising:
a receiver configured to receive authentication request information from the user terminal to access a network;
an EAP authentication procedure processor configured to process an authentication procedure according to the authentication request information; and
a transmitter configured to transmit a message related to the EAP authentication procedure to the user terminal,
wherein the message includes network rejection information when network rejection is triggered, and the network rejection information includes network rejection reason information and control information for a user terminal to cope with the network rejection.

10. A method for authenticating a user terminal, comprising:
transmitting authentication request information for accessing a network to an authentication server; and
receiving a message related to an EAP authentication procedure processed according to the authentication request information from the authentication server,
wherein the message includes network rejection information when network rejection is triggered, and the network rejection information includes network rejection reason information and control information for the user terminal to cope with the network rejection.

11. The method of claim 10, further comprising performing control operations according to the control information.

12. The method of claim 10, wherein the message is an EAP message and further includes delimiter information.

13. The method of claim 12, wherein the network rejection information is coded by a Type-Length-Value (TLV).

14. The method of claim 13, wherein the TLV coded network rejection information is in a human unreadable format and is not displayed through a display device of the user terminal if is not converted into a human readable format.

15. The method of claim 13, wherein the TLV coded network rejection information is included in a Type-Data field of the EAP message.

16. The method of claim 10, wherein the network rejection information further includes authentication rejection reason information for integrity protection for the network rejection information.

17. The method of claim 16, wherein the rejection reason authentication information is generated using a Master Session Key (MSK) or an Extended Master Session Key (EMSK).

18. The method of claim 17, wherein the integrity protection is performed by comparing the rejection reasons authentication information with rejection reason authentication server of the authentication server, which is generated using a MSK or an EMSK of the authentication server.

19. An apparatus for authenticating a user terminal, comprising:
a transmitter configured to transmit authentication request information for accessing a network to an authentication server; and
a receiver configured to receive a message related to an EAP authentication procedure processed according to the authentication request information from the authentication server,
wherein the message includes network rejection information when network rejection is triggered, and the network rejection information includes network rejection reason information and control information for the user terminal to cope with the network rejection.

20. A method for authenticating a user terminal, comprising:
receiving authentication request information for accessing a network from the user terminal;
processing an EAP-TLS authentication procedure according to the authentication request information; and
transmitting a EAP-Request/Notification message related to the EAP-TLS authentication procedure to the user terminal,
wherein the EAP-Request/Notification message includes the network rejection information when network rejection is triggered, and the network rejection information includes network rejection reason information and control information for the user terminal to cope with the network rejection.

21. A method for authenticating a user terminal, comprising:
receiving authentication request information for accessing a network from the user terminal;
processing an EAP-TTLS authentication procedure according to the authentication request information; and
transmitting a EAP-Request/Notification message related to the EAP-TTLS authentication procedure to the user terminal,
wherein the EAP-Request/Notification message includes the network rejection information when network rejection related to authentication failure or authorization failure is triggered during the the EAP-TTLS authentication procedure, and the network rejection information includes network rejection reason information and control information for the user terminal to cope with the network rejection.

22. A method for authenticating a user terminal, comprising:
receiving authentication request information for accessing a network from the user terminal;
processing an EAP-AKA authentication procedure according to the authentication request information; and
transmitting a EAP-Request/Notification message related to the EAP-AKA authentication procedure to the user terminal,
wherein the EAP-Request/Notification message includes the network rejection information when network rejection is triggered, and the network rejection information includes network rejection reason information and control information for the user terminal to cope with the network rejection.
